(19) United States
(12) Patent Application Publication
(10) Pub. No.: US 2025/0013928 A1
(43) Pub. Date: Jan. 9, 2025

(54) TRAINING DATA SELECTION DEVICE, TRAINING DATA SELECTION METHOD, AND ANOMALY DETECTION DEVICE

(71) Applicant: Mitsubishi Electric Corporation, Tokyo (JP)

(72) Inventors: Shinya TSURUTA, Tokyo (JP); Daisuke TAKAHASHI, Tokyo (JP)

(73) Assignee: Mitsubishi Electric Corporation, Tokyo (JP)

(21) Appl. No.: 18/894,083

(22) Filed: Sep. 24, 2024

Related U.S. Application Data
(63) Continuation of application No. PCT/JP2022/015753, filed on Mar. 30, 2022.

(51) Int. Cl. G06N 20/00

(52) U.S. Cl. CPC G06N 20/00

(57) ABSTRACT

A training data selection method includes: acquiring pieces of sensor data indicating an observation result of a fault detection target from a sensor to observe the target; giving each piece of sensor data to a learning model that has learned a distribution of pieces of sensor data when the target is normal, and acquiring each piece of detection data indicating whether the target is normal or abnormal from the learning model; and acquiring identification information for identifying which piece of sensor data is related to false negative detection data indicating that the target is normal although the target is abnormal, and selecting, based on the identification information, a piece of sensor data related to detection data indicating that the target is normal as training data used for retraining of the learning model from pieces of sensor data other than the sensor data related to the false negative detection data.

### CROSS REFERENCE TO RELATED APPLICATION

This application is a Continuation of PCT International Application No. PCT/JP2022/015753, filed on Mar. 30, 2022, which is hereby expressly incorporated by reference into the present application.

### TECHNICAL FIELD

The present disclosure relates to a training data selection device, a training data selection method, and an anomaly detection device.

### BACKGROUND ART

There is an anomaly detection device that acquires sensor data from a sensor that observes a fault detection target, gives the sensor data to a learning model, and acquires detection data indicating whether the fault detection target is normal or abnormal from the learning model (See, for example, Patent Literature 1.). In the learning model, it is assumed that sensor data when the fault detection target is normal is given to the learning model as training data, and the learning model is trained by the distribution of sensor data when the fault detection target is normal. The sensor data when the fault detection target is normal is, for example, sensor data output from the sensor within a period of an initial operation stage of the fault detection target.

In the anomaly detection device, retraining of the learning model may be performed in order to improve detection accuracy of the learning model. Training data used for retraining of the learning model includes sensor data for additional learning and sensor data within a normal period of the fault detection target.

The sensor data for additional learning is sensor data when there is high possibility that erroneous detection of anomaly has occurred although the fault detection target is normal. The sensor data within a normal period of the fault detection target is sensor data determined to be within the normal period at any evaluation time.

### CITATION LIST

### Patent Literature

Patent Literature 1: JP 2019-28565 A

### SUMMARY OF INVENTION

### Technical Problem

In the anomaly detection device disclosed in Patent Literature 1, pieces of sensor data determined to be within the normal period of the fault detection target is used as training data used for retraining of the learning model among pieces of sensor data at any evaluation time. However, in a case where an initial fault occurs in the fault detection target in the initial operation stage or aged deterioration occurs in the fault detection target, pieces of sensor data when the fault detection target is abnormal may be included in the sensor data within the normal period. Therefore, among the pieces of sensor data at any evaluation time, the sensor data determined to be within the normal period of the fault detection target may also include sensor data erroneously detected to be normal although the fault detection target is abnormal. In a case where the training data used for retraining of the learning model includes the sensor data when the fault detection target is abnormal, even when retraining of the learning model is performed, there is still a problem that the anomaly detection device may erroneously detect that the fault detection target is normal although the fault detection target is abnormal.

The present disclosure has been made in order to solve the above problem, and an object thereof is to obtain a training data selection device and a training data selection method capable of selecting training data capable of reducing erroneous detection that a fault detection target is detected to be normal although the fault detection target is abnormal.

### Solution to Problem

A training data selection device according to the present disclosure includes: processing circuitry to perform acquisition of a plurality of pieces of sensor data indicating an observation result of a fault detection target from a sensor to observe the fault detection target, to give each of the plurality of pieces of sensor data to a learning model that has learned a distribution of the plurality of pieces of sensor data when the fault detection target is normal, and to acquire each of pieces of detection data indicating whether the fault detection target is normal or abnormal from the learning model, and to acquire identification information for identifying which piece of sensor data among the plurality of pieces of sensor data is related to false negative detection data indicating that the fault detection target is normal although the fault detection target is abnormal, and to perform selection of, on a basis of the identification information, a piece of sensor data related to detection data indicating that the fault detection target is normal as training data used for retraining of the learning model from other pieces of sensor data which are other than the piece of sensor data identified to be related to the false negative detection data among the plurality of pieces of sensor data, and to output the selected piece of sensor data for retraining.

### Advantageous Effects of Invention

According to the present disclosure, it is possible to select training data capable of reducing erroneous detection that the fault detection target is detected to be normal although the fault detection target is abnormal.

### BRIEF DESCRIPTION OF DRAWINGS

FIG. 1 is a configuration diagram illustrating a training data selection device 2 according to a first embodiment.

FIG. 2 is a hardware configuration diagram illustrating hardware of the training data selection device 2 according to the first embodiment.

FIG. 3 is a hardware configuration diagram of a computer in a case where the training data selection device 2 is implemented by software, firmware, or the like.

FIG. 4 is a flowchart illustrating a training data selection method which is a processing procedure performed in the training data selection device 2.

FIG. 5 is an explanatory diagram illustrating a distribution of pieces of sensor data learned by a learning model 13 when a fault detection target is normal.

FIG. 6 is an explanatory diagram illustrating an example of sensor data displayed on a display.

FIG. 7 is an explanatory diagram illustrating a distribution of pieces of sensor data relearned by the learning model 13.

FIG. 8 is a configuration diagram illustrating a training data selection device 2 according to a second embodiment.

FIG. 9 is a hardware configuration diagram illustrating hardware of the training data selection device 2 according to the second embodiment.

FIG. 10 is an explanatory diagram illustrating two pieces of false negative sensor data, two pieces of false positive sensor data, and four pieces of normal sensor data.

FIG. 11 is an explanatory diagram illustrating first evaluation values and second evaluation values in each of the four pieces of normal sensor data illustrated in FIG. 10.

FIG. 12 is a configuration diagram illustrating a training data selection device 2 according to a third embodiment.

FIG. 13 is an explanatory diagram illustrating first evaluation values, second evaluation values, and a third evaluation value in each of the four pieces of normal sensor data illustrated in FIG. 10.

FIG. 14 is a configuration diagram illustrating a training data selection device 2 according to a fourth embodiment.

FIG. 15 is a hardware configuration diagram illustrating hardware of the training data selection device 2 according to the fourth embodiment.

FIG. 16 is an explanatory diagram illustrating a ratio at which training data output from a training data selecting unit 14 is included in training data used for previous training of a learning model 13.

FIG. 17 is a configuration diagram illustrating an anomaly detection device according to a fifth embodiment.

FIG. 18 is a hardware configuration diagram illustrating hardware of the anomaly detection device according to the fifth embodiment.

### DESCRIPTION OF EMBODIMENTS

Hereinafter, in order to describe the present disclosure in more detail, embodiments for carrying out the present disclosure will be described with reference to the attached drawings.

### First Embodiment

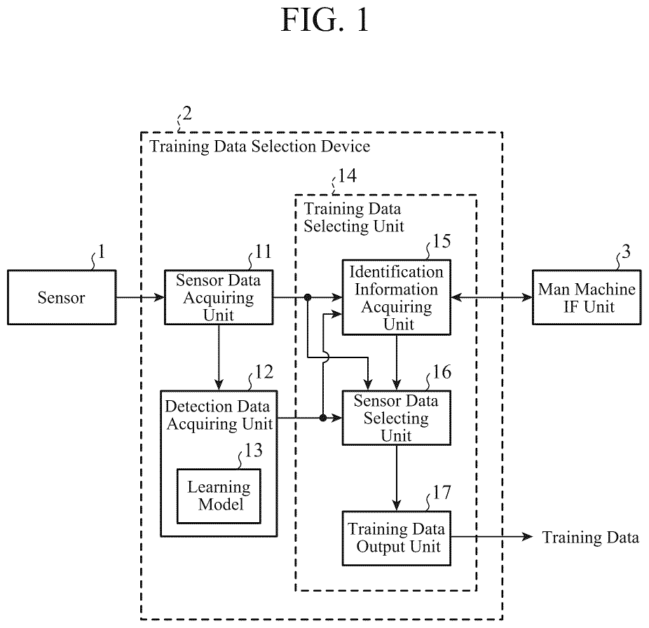

FIG. 1 is a configuration diagram illustrating a training data selection device 2 according to a first embodiment.

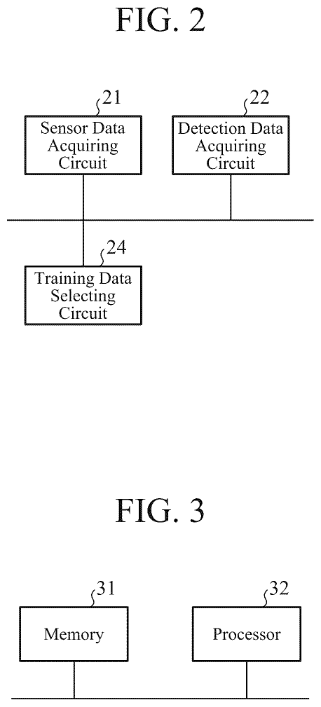

FIG. 2 is a hardware configuration diagram illustrating hardware of the training data selection device 2 according to the first embodiment.

In FIG. 1, a sensor 1 repeatedly observes a fault detection target.

The sensor 1 outputs a plurality of pieces of sensor data indicating an observation result of the fault detection target to the training data selection device 2.

The training data selection device 2 includes a sensor data acquiring unit 11, a detection data acquiring unit 12, and a training data selecting unit 14.

A man machine interface unit (hereinafter, referred to as “man machine IF unit”) 3 includes an input device and an output device. The input device is a device that receives a user's operation, and is implemented by, for example, a mouse or a keyboard. The output device is implemented by a display device or the like that displays sensor data or the like output from the training data selection device 2.

The sensor data acquiring unit 11 is implemented by, for example, a sensor data acquiring circuit 21 illustrated in FIG. 2.

The sensor data acquiring unit 11 acquires a plurality of pieces of sensor data indicating an observation result of the fault detection target from the sensor 1.

The sensor data acquiring unit 11 outputs each of the pieces of sensor data to each of the detection data acquiring unit 12 and the training data selecting unit 14.

The detection data acquiring unit 12 is implemented by, for example, a detection data acquiring circuit 22 illustrated in FIG. 2.

The detection data acquiring unit 12 includes a learning model 13.

The detection data acquiring unit 12 gives each of the pieces of sensor data acquired by the sensor data acquiring unit 11 to the learning model 13, and acquires each of pieces of detection data indicating whether the fault detection target is normal or abnormal from the learning model 13.

The detection data acquiring unit 12 outputs each of the pieces of detection data to the training data selecting unit 14.

In the training data selection device 2 illustrated in FIG. 1, the detection data acquiring unit 12 includes the learning model 13. However, this is merely an example, and the learning model 13 may be disposed outside the detection data acquiring unit 12.

The learning model 13 is implemented by, for example, a neural network.

The learning model 13 is, for example, an unsupervised learning model.

At the time of training, sensor data when the fault detection target is normal is given to the learning model 13, and the learning model 13 has learned a distribution of pieces of the sensor data.

At the time of inference, when sensor data when the fault detection target is normal is given to the learning model 13, the learning model 13 outputs detection data indicating that the fault detection target is normal. When sensor data when the fault detection target is abnormal is given to the learning model 13, the learning model 13 outputs detection data indicating that the fault detection target is abnormal.

Note that, in a case where detection accuracy of the learning model 13 is low, erroneous detection may occur in which the learning model 13 outputs false positive detection data indicating that the fault detection target is abnormal although the fault detection target is normal, or false negative detection data indicating that the fault detection target is normal although the fault detection target is abnormal.

The training data selecting unit 14 is implemented by, for example, a training data selecting circuit 24 illustrated in FIG. 2.

The training data selecting unit 14 includes an identification information acquiring unit 15, a sensor data selecting unit 16, and a training data output unit 17.

The training data selecting unit 14 acquires identification information for identifying which piece of sensor data among the plurality of pieces of sensor data acquired by the sensor data acquiring unit 11 is related to false negative detection data indicating that the fault detection target is normal although the fault detection target is abnormal.

The training data selecting unit 14 selects a piece of sensor data related to detection data indicating that the fault detection target is normal as training data used for retraining of the learning model 13 from pieces of sensor data other than the piece of sensor data related to false negative detection data among the plurality of pieces of sensor data acquired by the sensor data acquiring unit 11 on the basis of the identification information.

In addition, the training data selecting unit 14 acquires identification information for identifying which piece of sensor data among the plurality of pieces of sensor data acquired by the sensor data acquiring unit 11 is related to false positive detection data indicating that the fault detection target is abnormal although the fault detection target is normal.

The training data selecting unit 14 selects a piece of sensor data related to the false positive detection data as training data used for retraining of the learning model 13 from the plurality of pieces of sensor data acquired by the sensor data acquiring unit 11 on the basis of the identification information.

The training data selecting unit 14 outputs the selected piece of sensor data to the outside as training data used for retraining of the learning model 13.

The identification information acquiring unit 15 acquires each piece of sensor data from the sensor data acquiring unit 11, and acquires each piece of detection data from the detection data acquiring unit 12.

The identification information acquiring unit 15 outputs each piece of sensor data and each piece of detection data to the man machine IF unit 3. The man machine IF unit 3 displays each piece of sensor data on, for example, a display together with a detection result indicated by each piece of detection data. When the sensor data displayed on the display is related to false positive detection data, a user sets identification information indicating that the sensor data is related to false positive detection data by operating the input device of the man machine IF unit 3. The man machine IF unit 3 outputs the set identification information to the identification information acquiring unit 15. In addition, when the sensor data displayed on the display is related to false negative detection data, a user sets identification information indicating that the sensor data is related to false negative detection data by operating the input device of the man machine IF unit 3. The man machine IF unit 3 outputs the set identification information to the identification information acquiring unit 15. Furthermore, when the sensor data displayed on the display is related to detection data under normal conditions indicating that the fault detection target is normal when the fault detection target is normal, a user sets identification information indicating that the sensor data is related to detection data under normal conditions by operating the input device of the man machine IF unit 3. The man machine IF unit 3 outputs the set identification information to the identification information acquiring unit 15.

The identification information acquiring unit 15 acquires the identification information output from the man machine IF unit 3 and outputs the identification information to the sensor data selecting unit 16.

Here, when the sensor data displayed on the display is related to detection data under normal conditions indicating that the fault detection target is normal when the fault detection target is normal, a user sets identification information indicating that the sensor data is related to detection data under normal conditions by operating the input device of the man machine IF unit 3. The man machine IF unit 3 outputs the set identification information to the identification information acquiring unit 15. However, this is merely an example, and a user does not have to set the identification information indicating that the sensor data is related to detection data under normal conditions by operating the input device of the man machine IF unit 3. In this case, the man machine IF unit 3 does not output identification information indicating that the sensor data is related to detection data under normal conditions to the identification information acquiring unit 15.

The sensor data selecting unit 16 acquires each piece of sensor data from the sensor data acquiring unit 11, acquires each piece of detection data from the detection data acquiring unit 12, and acquires identification information from the identification information acquiring unit 15.

The sensor data selecting unit 16 selects a piece of sensor data related to detection data under normal conditions from the plurality of pieces of sensor data acquired by the sensor data acquiring unit 11 on the basis of the identification information.

In addition, the sensor data selecting unit 16 selects a piece of sensor data related to false positive detection data from the plurality of pieces of sensor data acquired by the sensor data acquiring unit 11 on the basis of the identification information.

The sensor data selecting unit 16 outputs the sensor data related to detection data under normal conditions and the sensor data related to false positive detection data to the training data output unit 17.

The training data output unit 17 acquires the sensor data related to detection data under normal conditions and the sensor data related to false positive detection data from the sensor data selecting unit 16.

When a similarity between the sensor data related to detection data under normal conditions and the sensor data related to false positive detection data is equal to or more than a threshold, the training data output unit 17 outputs the sensor data related to detection data under normal conditions to the outside as training data used for retraining of the learning model 13.

When the similarity is less than the threshold, the training data output unit 17 discards the sensor data related to detection data under normal conditions without outputting the sensor data to the outside as training data used for retraining of the learning model 13.

The training data output unit 17 outputs the sensor data related to false positive detection data to the outside as training data used for retraining of the learning model 13. The threshold may be stored in an internal memory of the training data output unit 17 or may be given from the outside of the training data selection device 2.

In FIG. 1, it is assumed that each of the sensor data acquiring unit 11, the detection data acquiring unit 12, and the training data selecting unit 14, which are constituent elements of the training data selection device 2, is implemented by dedicated hardware as illustrated in FIG. 2. That is, it is assumed that the training data selection device 2 is implemented by the sensor data acquiring circuit 21, the detection data acquiring circuit 22, and the training data selecting circuit 24.

A single circuit, a composite circuit, a programmed processor, a parallel programmed processor, an application specific integrated circuit (ASIC), a field-programmable gate array (FPGA), or a combination thereof corresponds to each of the sensor data acquiring circuit 21, the detection data acquiring circuit 22, and the training data selecting circuit 24.

The constituent elements of the training data selection device 2 are not limited to those implemented by dedicated hardware, and the training data selection device 2 may be implemented by software, firmware, or a combination of software and firmware.

Software or firmware is stored as a program in a memory of a computer. The computer means hardware that executes a program. To the computer, for example, a central processing unit (CPU), a central processing device, a processing device, an arithmetic device, a microprocessor, a microcomputer, a processor, or a digital signal processor (DSP) corresponds.

FIG. 3 is a hardware configuration diagram of a computer in a case where the training data selection device 2 is implemented by software, firmware, or the like.

When the training data selection device 2 is implemented by software, firmware, or the like, a program for causing a computer to execute processing procedures performed in each of the sensor data acquiring unit 11, the detection data acquiring unit 12, and the training data selecting unit 14 is stored in a memory 31. A processor 32 of the computer executes the program stored in the memory 31.

FIG. 2 illustrates an example in which each of the constituent elements of the training data selection device 2 is implemented by dedicated hardware, and FIG. 3 illustrates an example in which the training data selection device 2 is implemented by software, firmware, or the like. However, this is merely an example, and some of the constituent elements of the training data selection device 2 may be implemented by dedicated hardware, and the remaining constituent elements may be implemented by software, firmware, or the like.

Next, an operation of the training data selection device 2 illustrated in FIG. 1 will be described.

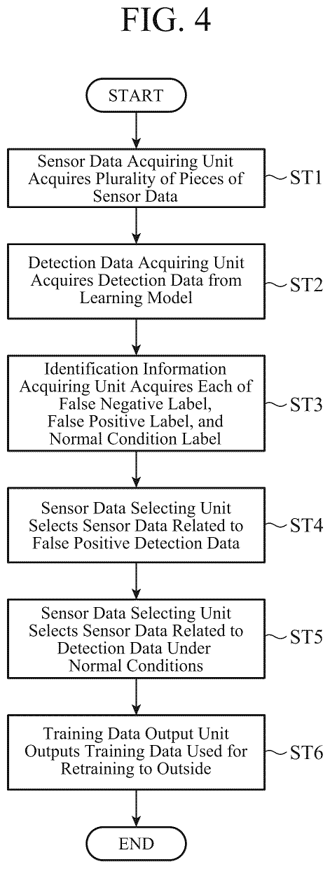

FIG. 4 is a flowchart illustrating a training data selection method which is a processing procedure performed in the training data selection device 2.

In the training data selection device 2 illustrated in FIG. 1, the fault detection target is, for example, a shaft connected to an engine of an automobile, and the sensor data output from the sensor 1 is, for example, a frequency of the shaft. Note that the fault detection target is not limited to the shaft, and the sensor data is not limited to the frequency of the shaft. For example, the fault detection target may be an air conditioner, and the sensor data may be consumed power.

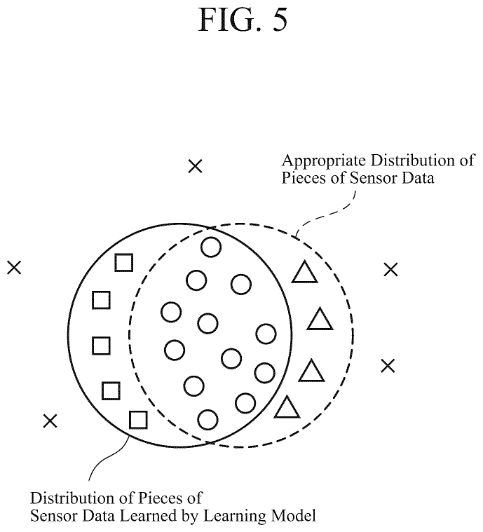

FIG. 5 is an explanatory diagram illustrating a distribution of pieces of sensor data learned by the learning model 13 when the fault detection target is normal.

In FIG. 5, ◯, Δ, □, and x each represent a piece of sensor data related to detection data output from the learning model 13.

In particular, ◯ represents a piece of sensor data related to detection data under normal conditions indicating that the fault detection target is normal when the fault detection target is normal, and Δ represents a piece of sensor data related to false positive detection data indicating that the fault detection target is abnormal although the fault detection target is normal.

□ represents a piece of sensor data related to false negative detection data indicating that the fault detection target is normal although the fault detection target is abnormal, and x represents a piece of sensor data related to detection data at abnormal time indicating that the fault detection target is abnormal when the fault detection target is abnormal.

A detection result of each of the false positive detection data and the false negative detection data is erroneous detection.

In order to reduce erroneous detection, retraining of the learning model 13 is necessary. When the sensor data related to false positive detection data is used as training data used for retraining, the distribution of pieces of sensor data when the fault detection target is normal includes the sensor data related to false positive detection data. Since the sensor data related to false positive detection data is sensor data when the fault detection target is normal, the distribution of pieces of sensor data when the fault detection target is normal is an appropriate distribution, and as a result, false positive erroneous detection is reduced.

When the sensor data related to false negative detection data is used as training data used for retraining, the distribution of pieces of sensor data when the fault detection target is normal includes the sensor data related to false negative detection data. Since the sensor data related to false negative detection data is sensor data when the fault detection target is abnormal, the distribution of pieces of sensor data when the fault detection target is normal is an inappropriate distribution, and as a result, false negative erroneous detection may occur. When the sensor data related to false negative detection data is not used as training data used for retraining, the distribution of pieces of sensor data when the fault detection target is normal does not include the sensor data related to false negative detection data. As a result, false negative erroneous detection is reduced.

When the sensor data when the fault detection target is normal is used as training data used for retraining, a distribution of pieces of sensor data when the fault detection target is normal is formed.

Therefore, it is useful to use the sensor data related to false positive detection data and the sensor data related to detection data under normal conditions as training data used for retraining of the learning model 13.

Meanwhile, the sensor data related to false negative detection data and the sensor data related to detection data at abnormal time should not be used as training data used for retraining of the learning model 13.

Note that, among a plurality of pieces of sensor data related to detection data under normal conditions, a piece of sensor data close to the center of a distribution of the pieces of sensor data is less effective in clarifying the distribution of the pieces of sensor data when the fault detection target is normal than a piece of sensor data close to the sensor data related to false positive detection data. Therefore, it is less necessary to use the piece of sensor data close to the center of the distribution of the pieces of sensor data as training data from a viewpoint of reducing the number of pieces of the training data and performing efficient learning.

The sensor 1 repeatedly observes the fault detection target.

The sensor 1 outputs a plurality of pieces of sensor data indicating an observation result of the fault detection target to the sensor data acquiring unit 11 of the training data selection device 2.

The sensor data acquiring unit 11 acquires the plurality of pieces of sensor data indicating the observation result of the fault detection target from the sensor 1 (step ST1 in FIG. 4).

The sensor data acquiring unit 11 outputs each of the pieces of sensor data to each of the detection data acquiring unit 12 and the training data selecting unit 14.

The detection data acquiring unit 12 outputs each of the pieces of sensor data from the sensor data acquiring unit 11.

The detection data acquiring unit 12 gives each of the pieces of sensor data to the learning model 13, and acquires each of pieces of detection data indicating whether the fault detection target is normal or abnormal from the learning model 13 (step ST2 in FIG. 4).

The detection data acquiring unit 12 outputs each of pieces of the detection data to the training data selecting unit 14.

Depending on detection accuracy of the learning model 13, false positive detection data or false negative detection data may be included in the plurality of pieces of detection data output from the learning model 13 in addition to detection data under normal conditions and detection data at abnormal time.

When false positive detection data or false negative detection data is included in the plurality of pieces of detection data output from the learning model 13 and the number of included pieces of false positive detection data or the like is large, retraining of the learning model 13 should be performed.

The identification information acquiring unit 15 acquires each piece of sensor data from the sensor data acquiring unit 11, and acquires each piece of detection data from the detection data acquiring unit 12.

The identification information acquiring unit 15 outputs each piece of sensor data and each piece of detection data to the man machine IF unit 3.

The man machine IF unit 3 displays each piece of sensor data on, for example, a display together with a detection result indicated by each piece of detection data.

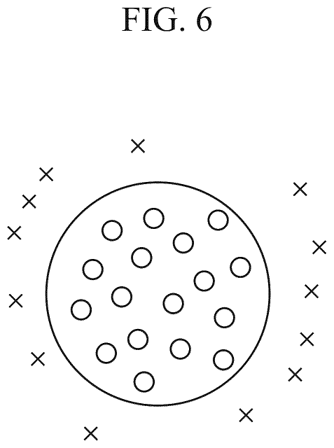

FIG. 6 is an explanatory diagram illustrating an example of sensor data displayed on a display.

In FIG. 6, ◯ represents a piece of sensor data indicating that the fault detection target is normal. Note that ◯ may include a piece of sensor data related to false negative detection data in addition to a piece of sensor data related to detection data under normal conditions.

x represents a piece of sensor data indicating that the fault detection target is abnormal. Note that x may include a piece of sensor data related to false positive detection data in addition to a piece of sensor data related to detection data at abnormal time.

When determining that a piece of sensor data related to false negative detection data is included in the sensor data represented by ◯, a user viewing the display designates a piece of sensor data considered to be a piece of sensor data related to false negative detection data by operating the input device of the man machine IF unit 3.

The man machine IF unit 3 outputs identification information (hereinafter, referred to as “false negative label”) indicating that the designated piece of sensor data is a piece of sensor data related to false negative detection data to the identification information acquiring unit 15.

When determining that a piece of sensor data related to false positive detection data is included in the sensor data represented by x, a user viewing the display designates a piece of sensor data considered to be a piece of sensor data related to false positive detection data by operating the input device of the man machine IF unit 3.

The man machine IF unit 3 outputs identification information (hereinafter, referred to as “false positive label”) indicating that the designated piece of sensor data is a piece of sensor data related to false positive detection data to the identification information acquiring unit 15.

When determining that a piece of sensor data related to detection data under normal conditions is included in the sensor data represented by ◯, a user viewing the display designates a piece of sensor data considered to be a piece of sensor data related to detection data under normal conditions by operating the input device of the man machine IF unit 3.

The man machine IF unit 3 outputs identification information (hereinafter, referred to as “normal condition label”) indicating that the designated piece of sensor data is a piece of sensor data related to detection data under normal conditions to the identification information acquiring unit 15.

Here, a user designates a piece of sensor data considered to be a piece of sensor data related to detection data under normal conditions by operating the input device of the man machine IF unit 3, and the man machine IF unit 3 outputs the normal condition label to the identification information acquiring unit 15. However, this is merely an example, and a user does not have to designate a piece of sensor data considered to be a piece of sensor data related to detection data under normal conditions by operating the input device of the man machine IF unit 3. In this case, the man machine IF unit 3 does not output the normal condition label to the identification information acquiring unit 15.

The identification information acquiring unit 15 acquires each of the false negative label, the false positive label, and the normal condition label from the man machine IF unit 3 (step ST3 in FIG. 4).

The identification information acquiring unit 15 outputs each of the false negative label, the false positive label, and the normal condition label to the sensor data selecting unit 16.

When the normal condition label is not output from the man machine IF unit 3 to the identification information acquiring unit 15, the identification information acquiring unit 15 acquires each of the false negative label and the false positive label from the man machine IF unit 3, and the identification information acquiring unit 15 outputs each of the false negative label and the false positive label to the sensor data selecting unit 16.

The sensor data selecting unit 16 acquires each piece of sensor data from the sensor data acquiring unit 11, and acquires each piece of detection data from the detection data acquiring unit 12.

In addition, the sensor data selecting unit 16 acquires each of the false negative label, the false positive label, and the normal condition label from the identification information acquiring unit 15.

The sensor data selecting unit 16 selects a piece of sensor data related to false positive detection data from the plurality of pieces of sensor data acquired by the sensor data acquiring unit 11 on the basis of the false positive label (step ST4 in FIG. 4).

The sensor data selecting unit 16 outputs the sensor data related to false positive detection data to the training data output unit 17.

The sensor data selecting unit 16 selects one or more pieces of sensor data related to detection data under normal conditions from the plurality of pieces of sensor data acquired by the sensor data acquiring unit 11 on the basis of the normal condition label (step ST5 in FIG. 4).

The sensor data selecting unit 16 outputs each of pieces of the sensor data related to detection data under normal conditions to the training data output unit 17.

When the normal condition label is not output from the identification information acquiring unit 15, the sensor data selecting unit 16 selects a piece of sensor data other than sensor data related to false negative detection data as the sensor data related to detection data under normal conditions from pieces of the sensor data related to detection data indicating that the fault detection target is normal among the plurality of pieces of sensor data acquired by the sensor data acquiring unit 11 on the basis of the false negative label.

The training data output unit 17 acquires each piece of the sensor data related to detection data under normal conditions and each piece of the sensor data related to false positive detection data from the sensor data selecting unit 16.

The training data output unit 17 calculates a similarity between each piece of the sensor data related to detection data under normal conditions and each piece of the sensor data related to false positive detection data. Examples of those indicating the similarity include a Euclidean distance between each piece of the sensor data related to detection data under normal conditions and each piece of the sensor data related to false positive detection data. The training data output unit 17 can specify the position of a piece of the sensor data related to detection data under normal conditions in a Euclidean space and the position of a piece of the sensor data related to false positive detection data in the Euclidean space, and can calculate a linear distance between the specified two positions as the Euclidean distance.

The training data output unit 17 selects a piece of sensor data having a similarity equal to or more than a threshold from the plurality of pieces of sensor data related to detection data under normal conditions output from the sensor data selecting unit 16.

The training data output unit 17 outputs the piece of sensor data having a similarity equal to or more than the threshold to the outside as training data used for retraining of the learning model 13 (step ST6 in FIG. 4).

The training data output unit 17 discards a piece of sensor data having a similarity less than the threshold without outputting the piece of sensor data to the outside.

In addition, the training data output unit 17 outputs the sensor data related to false positive detection data to the outside as training data used for retraining of the learning model 13 (step ST6 in FIG. 4).

The learning model 13 relearns the distribution of pieces of sensor data when the fault detection target is normal using the sensor data output from the training data output unit 17.

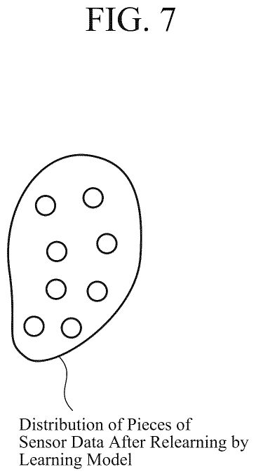

FIG. 7 is an explanatory diagram illustrating a distribution of pieces of sensor data relearned by the learning model 13.

As illustrated in FIG. 7, the distribution of pieces of sensor data after relearning includes only a piece of sensor data when the fault detection target is normal, and does not include a piece of sensor data related to false negative detection data. As a result, the distribution of pieces of sensor data when the fault detection target is normal is an appropriate distribution.

In the example of FIG. 7, the distribution of pieces of sensor data relearned by the learning model 13 includes sensor data related to four pieces of false positive detection data illustrated in FIG. 5 and sensor data related to four pieces of detection data under normal conditions illustrated in FIG. 5.

In the above first embodiment, the training data selection device 2 is configured in such a manner as to include: the sensor data acquiring unit 11 that acquires a plurality of pieces of sensor data indicating an observation result of a fault detection target from the sensor 1 that observes the fault detection target; and the detection data acquiring unit 12 that gives each of the pieces of sensor data acquired by the sensor data acquiring unit 11 to the learning model 13 that has learned a distribution of pieces of sensor data when the fault detection target is normal, and that acquires each of pieces of detection data indicating whether the fault detection target is normal or abnormal from the learning model 13. In addition, the training data selection device 2 includes the training data selecting unit 14 that acquires identification information for identifying which piece of sensor data among the plurality of pieces of sensor data acquired by the sensor data acquiring unit 11 is related to false negative detection data indicating that the fault detection target is normal although the fault detection target is abnormal, and that selects, on the basis of the identification information, a piece of sensor data related to detection data indicating that the fault detection target is normal as training data used for retraining of the learning model 13 from pieces of sensor data other than the piece of sensor data related to the false negative detection data among the plurality of pieces of sensor data acquired by the sensor data acquiring unit 11. Therefore, the training data selection device 2 can select training data capable of reducing erroneous detection that the fault detection target is detected to be normal although the fault detection target is abnormal.

### Second Embodiment

In a second embodiment, a training data selection device 2 in which a training data selecting unit 41 includes an identification information acquiring unit 15, a data classification unit 42, an evaluation value calculating unit 43, a priority order calculating unit 44, and a training data output unit 45 will be described.

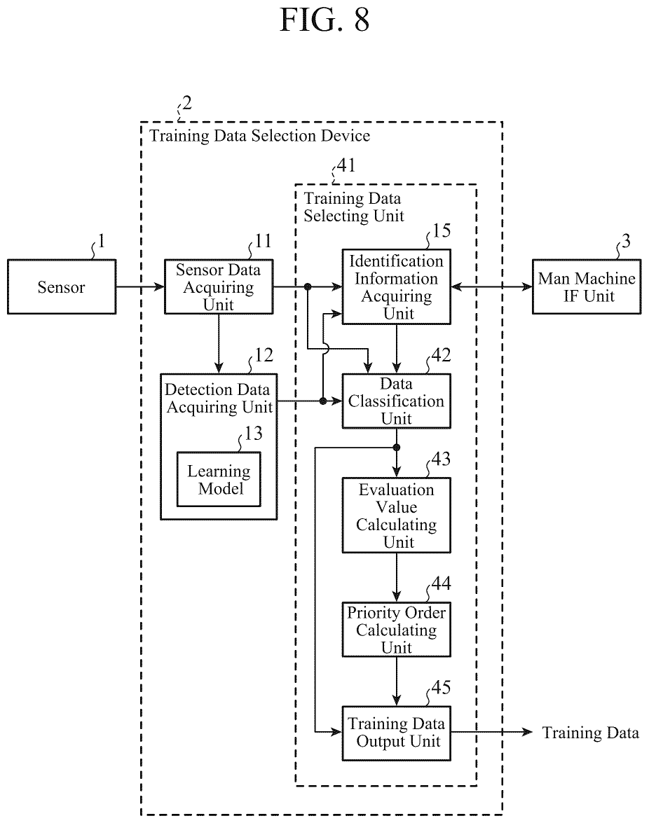

FIG. 8 is a configuration diagram illustrating the training data selection device 2 according to the second embodiment. In FIG. 8, the same reference numerals as in FIG. 1 indicate the same or corresponding parts, and therefore description thereof is omitted.

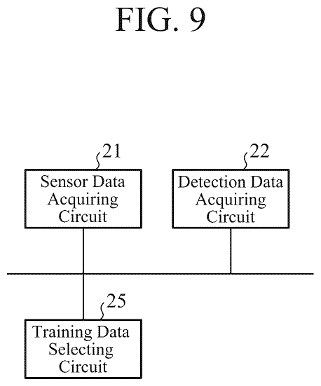

FIG. 9 is a hardware configuration diagram illustrating hardware of the training data selection device 2 according to the second embodiment. In FIG. 9, the same reference numerals as in FIG. 2 indicate the same or corresponding parts, and therefore description thereof is omitted.

The training data selection device 2 illustrated in FIG. 8 includes a sensor data acquiring unit 11, a detection data acquiring unit 12, and the training data selecting unit 41.

The training data selecting unit 41 is implemented by, for example, a training data selecting circuit 25 illustrated in FIG. 9.

The training data selecting unit 41 includes the identification information acquiring unit 15, the data classification unit 42, the evaluation value calculating unit 43, the priority order calculating unit 44, and the training data output unit 45.

The training data selecting unit 41 acquires identification information for identifying which piece of sensor data among the plurality of pieces of sensor data acquired by the sensor data acquiring unit 11 is related to false negative detection data indicating that the fault detection target is normal although the fault detection target is abnormal.

The training data selecting unit 41 selects a piece of sensor data related to detection data indicating that the fault detection target is normal as training data used for retraining of the learning model 13 from pieces of sensor data other than the piece of sensor data related to false negative detection data among the plurality of pieces of sensor data acquired by the sensor data acquiring unit 11 on the basis of the identification information.

In addition, the training data selecting unit 41 acquires identification information for identifying which piece of sensor data among the plurality of pieces of sensor data acquired by the sensor data acquiring unit 11 is related to false positive detection data indicating that the fault detection target is abnormal although the fault detection target is normal.

The training data selecting unit 41 selects a piece of sensor data related to the false positive detection data as training data used for retraining of the learning model 13 from the plurality of pieces of sensor data acquired by the sensor data acquiring unit 11 on the basis of the identification information.

The training data selecting unit 41 outputs the selected piece of sensor data to the outside as training data used for retraining of the learning model 13.

The data classification unit 42 acquires each piece of sensor data from the sensor data acquiring unit 11, and acquires each piece of detection data from the detection data acquiring unit 12.

In addition, the data classification unit 42 acquires each of a false negative label, a false positive label, and a normal condition label as identification information from the identification information acquiring unit 15.

On the basis of each of the false negative label, the false positive label, and the normal condition label, the data classification unit 42 classifies each of the pieces of sensor data acquired by the sensor data acquiring unit 11 into sensor data related to false negative detection data (hereinafter, referred to as “false negative sensor data”), sensor data related to false positive detection data (hereinafter, referred to as “false positive sensor data”), or sensor data related to detection data under normal conditions (hereinafter, referred to as “normal sensor data”).

The data classification unit 42 does not classify a piece of sensor data related to detection data at abnormal time among the plurality of pieces of sensor data acquired by the sensor data acquiring unit 11.

The data classification unit 42 outputs each of the false negative sensor data, the false positive sensor data, and the normal sensor data to the evaluation value calculating unit 43.

In addition, the data classification unit 42 outputs each of the false positive sensor data and the normal sensor data to the training data output unit 45.

When the normal condition label is not output from the identification information acquiring unit 15, the data classification unit 42 selects a piece of sensor data other than sensor data related to false negative detection data as the sensor data related to detection data under normal conditions from pieces of the sensor data related to detection data indicating that the fault detection target is normal among the plurality of pieces of sensor data acquired by the sensor data acquiring unit 11 on the basis of the false negative label. Then, the data classification unit 42 classifies the selected piece of sensor data into the normal sensor data.

The evaluation value calculating unit 43 acquires each of the false negative sensor data, the false positive sensor data, and the normal sensor data from the data classification unit 42. Here, for convenience of description, it is assumed that the number of pieces of normal sensor data output from the data classification unit 42 is plural.

The evaluation value calculating unit 43 calculates, as a first evaluation value of each piece of normal sensor data, a positive sign evaluation value having a larger absolute value as a similarity between each piece of normal sensor data and false positive sensor data is higher.

The evaluation value calculating unit 43 calculates, as a second evaluation value of each piece of normal sensor data, a negative sign evaluation value having a larger absolute value as a similarity between each piece of normal sensor data and false negative sensor data is higher.

The evaluation value calculating unit 43 outputs the first evaluation value of each piece of normal sensor data and the second evaluation value of each piece of normal sensor data to the priority order calculating unit 44.

The priority order calculating unit 44 acquires the first evaluation value of each piece of normal sensor data and the second evaluation value of each piece of normal sensor data from the evaluation value calculating unit 43.

The priority order calculating unit 44 calculates a priority order of each piece of normal sensor data on the basis of the first evaluation value of each piece of normal sensor data and the second evaluation value of each piece of normal sensor data.

The priority order calculating unit 44 outputs the priority order of each piece of normal sensor data to the training data output unit 45.

The training data output unit 45 selects one or more pieces of normal sensor data from the plurality of pieces of normal sensor data output from the data classification unit 42 on the basis of the priority order calculated by the priority order calculating unit 44.

The training data output unit 45 outputs the selected piece of normal sensor data and the false positive sensor data to the outside as training data used for retraining of the learning model.

In FIG. 8, it is assumed that each of the sensor data acquiring unit 11, the detection data acquiring unit 12, and the training data selecting unit 41, which are constituent elements of the training data selection device 2, is implemented by dedicated hardware as illustrated in FIG. 9. That is, it is assumed that the training data selection device 2 is implemented by a sensor data acquiring circuit 21, a detection data acquiring circuit 22, and a training data selecting circuit 25.

To each of the sensor data acquiring circuit 21, the detection data acquiring circuit 22, and the training data selecting circuit 25, for example, a single circuit, a composite circuit, a programmed processor, a parallel programmed processor, an ASIC, a FPGA, or a combination thereof corresponds.

The constituent elements of the training data selection device 2 are not limited to those implemented by dedicated hardware, and the training data selection device 2 may be implemented by software, firmware, or a combination of software and firmware.

When the training data selection device 2 is implemented by software, firmware, or the like, a program for causing a computer to execute processing procedures performed in each of the sensor data acquiring unit 11, the detection data acquiring unit 12, and the training data selecting unit 41 is stored in the memory 31 illustrated in FIG. 3. The processor 32 illustrated in FIG. 3 executes the program stored in the memory 31.

FIG. 9 illustrates an example in which each of the constituent elements of the training data selection device 2 is implemented by dedicated hardware, and FIG. 3 illustrates an example in which the training data selection device 2 is implemented by software, firmware, or the like. However, this is merely an example, and some of the constituent elements of the training data selection device 2 may be implemented by dedicated hardware, and the remaining constituent elements may be implemented by software, firmware, or the like.

Next, an operation of the training data selection device 2 illustrated in FIG. 8 will be described. Note that the training data selection device 2 is similar to the training data selection device 2 illustrated in FIG. 1 except for the training data selecting unit 41. Therefore, only an operation of the training data selecting unit 41 will be described here.

The data classification unit 42 acquires each piece of sensor data from the sensor data acquiring unit 11, and acquires each piece of detection data from the detection data acquiring unit 12.

In addition, the data classification unit 42 acquires each of a false negative label, a false positive label, and a normal condition label as identification information from the identification information acquiring unit 15.

The data classification unit 42 classifies each piece of sensor data into false negative sensor data, false positive sensor data, or normal sensor data on the basis of each of the false negative label, the false positive label, and the normal condition label.

When the data classification unit 42 cannot acquire the normal condition label from the identification information acquiring unit 15, the data classification unit 42 selects a piece of sensor data other than sensor data related to false negative detection data as sensor data related to detection data under normal conditions from pieces of the sensor data related to detection data indicating that the fault detection target is normal among the plurality of pieces of sensor data acquired by the sensor data acquiring unit 11 on the basis of the false negative label. Then, the data classification unit 42 classifies the selected piece of sensor data into the normal sensor data.

The data classification unit 42 does not classify a piece of sensor data related to detection data at abnormal time among the plurality of pieces of sensor data acquired by the sensor data acquiring unit 11.

The data classification unit 42 outputs each of the false negative sensor data, the false positive sensor data, and the normal sensor data to the evaluation value calculating unit 43.

In addition, the data classification unit 42 outputs each of the false positive sensor data and the normal sensor data to the training data output unit 45.

The evaluation value calculating unit 43 acquires each of the false negative sensor data, the false positive sensor data, and the normal sensor data from the data classification unit 42.

In the training data selection device 2 illustrated in FIG. 8, for convenience of description, it is assumed that the evaluation value calculating unit 43 acquires two pieces of false negative sensor data, two pieces of false positive sensor data, and four pieces of normal sensor data from the data classification unit 42.

The evaluation value calculating unit 43 calculates, as a first evaluation value EV_{Dm-FP1}, EV_{Dm-FP2} of each piece of normal sensor data, a positive sign evaluation value having a larger absolute value as a similarity between each piece of normal sensor data and false positive sensor data is higher. m=1, 2, 3, or 4 Examples of the first evaluation value EV_{Dm-FP1}, EV_{Dm-FP2} include a Euclidean distance. An absolute value of the Euclidean distance as the first evaluation value EV_{Dm-FP1}, EV_{Dm-FP2} is larger as a similarity between the normal sensor data and the false positive sensor data is higher. In addition, a sign of the Euclidean distance as the first evaluation value EV_{Dm-FP1}, EV_{Dm-FP2} is positive. The evaluation value calculating unit 43 can specify the position of a piece of the normal sensor data in a Euclidean space and the position of a piece of the false positive sensor data in the Euclidean space, and can calculate a linear distance between the position of the piece of the normal sensor data and the position of the piece of the false positive sensor data as the Euclidean distance.

The evaluation value calculating unit 43 calculates, as a second evaluation value EVD_{m-FN1}, EV_{Dm-FN2} of each piece of normal sensor data, a negative sign evaluation value having a larger absolute value as a similarity between each piece of normal sensor data and false negative sensor data is higher.

Examples of the second evaluation value EVD_{m-FN1}, EV_{Dm-FN2} include a Euclidean distance. An absolute value of the Euclidean distance as the second evaluation value EVD_{m-FN1}, EV_{Dm-FN2} is larger as a similarity between the normal sensor data and the false negative sensor data is higher. In addition, a sign of the Euclidean distance as the second evaluation value EVD_{m-FN1}, EV_{Dm-FN2} is negative.

The evaluation value calculating unit 43 outputs the first evaluation value EV_{Dm-FP1}, EV_{Dm-FP2} of each piece of the normal sensor data and the second evaluation value EVD_{m-FN1}, EV_{Dm-FN2} of each piece of the normal sensor data to the priority order calculating unit 44.

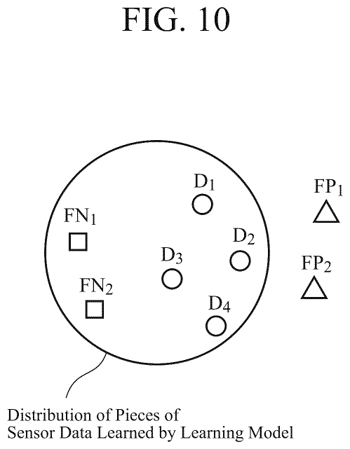

FIG. 10 is an explanatory diagram illustrating two pieces of false negative sensor data, two pieces of false positive sensor data, and four pieces of normal sensor data.

In FIG. 10, each of D₁, D₂, D₃, and D₄ represents a piece of normal sensor data, each of FP₁ and FP₂ represents a piece of false positive sensor data, and each of FN₁ and FN₂ represents a piece of false negative sensor data.

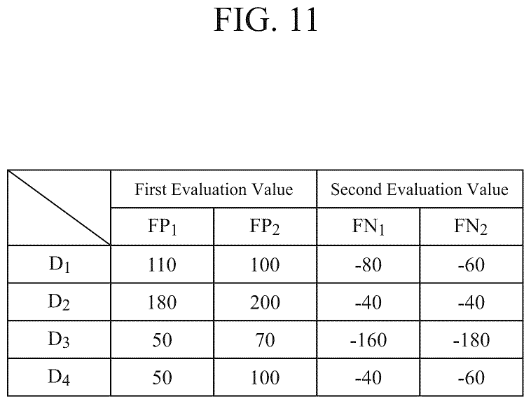

FIG. 11 is an explanatory diagram illustrating a first evaluation value and a second evaluation value in each of the four pieces of normal sensor data illustrated in FIG. 10.

In FIG. 11, a numerical value indicates the Euclidean distance as the first evaluation value or the Euclidean distance as the second evaluation value. Note that the numerical value illustrated in FIG. 11 does not indicate an accurate Euclidean distance, and is a schematic value.

The priority order calculating unit 44 acquires the first evaluation value EV_{Dm-FP1}, EV_{Dm-FP2} of each piece of the normal sensor data and the second evaluation value EVD_{m-FN1}, EV_{Dm-FN2} of each piece of the normal sensor data from the evaluation value calculating unit 43.

The priority order calculating unit 44 calculates a score SCₘ of each piece of the normal sensor data on the basis of the first evaluation value EV_{Dm-FP1}, EV_{Dm-FP2} of each piece of the normal sensor data and the second evaluation value EVD_{m-FN1}, EV_{Dm-FN2} of each piece of the normal sensor data as expressed by the following equations (1) to (4).

$$\begin{matrix}{SC}_{1} = {EV}_{D 1 - FP 1} + {EV}_{D 1 - FP 2} + {EV}_{D 1 - FN 1} + {EV}_{D 1 - FN 2} \\ = 110 + 100 - 80 - 60 \\ = 70\end{matrix} \qquad ( 1 )$$

$$\begin{matrix}{SC}_{2} = {EV}_{D 2 - FP 1} + {EV}_{D 2 - FP 2} + {EV}_{D 2 - FN 1} + {EV}_{D 2 - FN 2} \\ = 180 + 200 - 40 - 40 \\ = 300\end{matrix} \qquad ( 2 )$$

$$\begin{matrix}{SC}_{3} = {EV}_{D 3 - FP 1} + {EV}_{D 3 - FP 2} + {EV}_{D 3 - FN 1} + {EV}_{D 3 - FN 2} \\ = 50 + 70 - 160 - 180 \\ = - 220\end{matrix} \qquad ( 3 )$$

$$\begin{matrix}{SC}_{4} = {EV}_{D 4 - FP 1} + {EV}_{D 4 - FP 2} + {EV}_{D 4 - FN 1} + {EV}_{D 4 - FN 2} \\ = 50 + 100 - 40 - 60 \\ = 50\end{matrix} \qquad ( 4 )$$

The priority order calculating unit 44 compares the four scores SC₁ to SC₄ with each other, and calculates priority orders of the four pieces of normal sensor data D₁, D₂, D₃, and D₄ on the basis of a comparison result of the scores SC₁ to SC₄. The higher the score SCₘ, the higher the priority order of normal sensor data Dₘ.

In the example of FIG. 11, the priority order of the normal sensor data D₂ is the first, the priority order of the normal sensor data D₁ is the second, the priority order of the normal sensor data D₄ is the third, and the priority order of the normal sensor data D₃ is the fourth.

The priority order calculating unit 44 outputs the priority orders of the four pieces of normal sensor data D₁, D₂, D₃, and D₄ to the training data output unit 45.

The training data output unit 45 selects one or more pieces of normal sensor data from the four pieces of normal sensor data D₁, D₂, D₃, and D₄ output from the data classification unit 42 on the basis of the priority orders calculated by the priority order calculating unit 44.

Specifically, the training data output unit 45 selects N pieces (N is an integer of 1 or more) of normal sensor data with higher priority orders, calculated by the priority order calculating unit 44 from the four pieces of normal sensor data D₁, D₂, D₃, and D₄.

In the example of FIG. 11, if N=2, the normal sensor data D₂ and the normal sensor data D₁ are selected from the four pieces of normal sensor data D₁, D₂, D₃, and D₄.

If N=3, the normal sensor data D₂, the normal sensor data D₁ and the normal sensor data D₄ are selected from the four pieces of normal sensor data D₁, D₂, D₃, and D₄.

The training data output unit 45 outputs the selected piece of normal sensor data to the outside as training data used for retraining of the learning model.

In addition, the training data output unit 45 outputs false positive sensor data FP₁, FP₂ to the outside as training data used for retraining of the learning model.

In the above second embodiment, the training data selection device 2 illustrated in FIG. 8 is configured in such a manner that the training data selecting unit 41 includes the identification information acquiring unit 15, the data classification unit 42, the evaluation value calculating unit 43, the priority order calculating unit 44, and the training data output unit 45. Therefore, the training data selection device 2 illustrated in FIG. 8 can select training data capable of reducing erroneous detection that the fault detection target is detected to be normal although the fault detection target is abnormal similarly to the training data selection device 2 illustrated in FIG. 1. In addition, the training data selection device 2 illustrated in FIG. 8 can select training data capable of reducing erroneous detection that the fault detection target is abnormal although the fault detection target is normal.

In the training data selection device 2 illustrated in FIG. 8, the priority order calculating unit 44 calculates the scores SC₁, SC₂, SC₃, and SC₄ of the respective pieces of normal sensor data by adding the first evaluation value EV_{Dm-FP1}, EV_{Dm-FP2} of each piece of the normal sensor data and the second evaluation value EVD_{m-FN1}, EV_{Dm-FN2} of each piece of the normal sensor data. However, this is merely an example, and the priority order calculating unit 44 may calculate the scores SC₁, SC₂, SC₃, and SC₄ of the respective pieces of normal sensor data by calculating a weighted average of the first evaluation value EV_{Dm-FP1}, EV_{Dm-FP2} of each piece of the normal sensor data and the second evaluation value EVD_{m-FN1}, EV_{Dm-FN2} of each piece of the normal sensor data.

In the training data selection device 2 illustrated in FIG. 8, the training data output unit 45 selects N pieces of normal sensor data with higher priority orders, calculated by the priority order calculating unit 44 from the four pieces of normal sensor data D₁, D₂, D₃, and D₄. However, this is merely an example, and the training data output unit 45 selects one piece of normal sensor data in descending order of the priority order calculated by the priority order calculating unit 44 from the plurality of pieces of normal sensor data. Then, the training data output unit 45 may repeatedly select one piece of normal sensor data until the selected one piece of normal sensor data is given to the learning model 13, retraining of the learning model 13 is performed, and the detection accuracy of the learning model 13 after retraining is equal to or more than a threshold.

In this case, the training data selection device 2 can increase the detection accuracy of the learning model 13 after retraining to the threshold or more.

### Third Embodiment

In a third embodiment, a training data selection device 2 in which a priority order calculating unit 46 calculates a third evaluation value of each piece of normal sensor data on the basis of an acquisition time of each piece of normal sensor data by a sensor data acquiring unit 11 will be described.

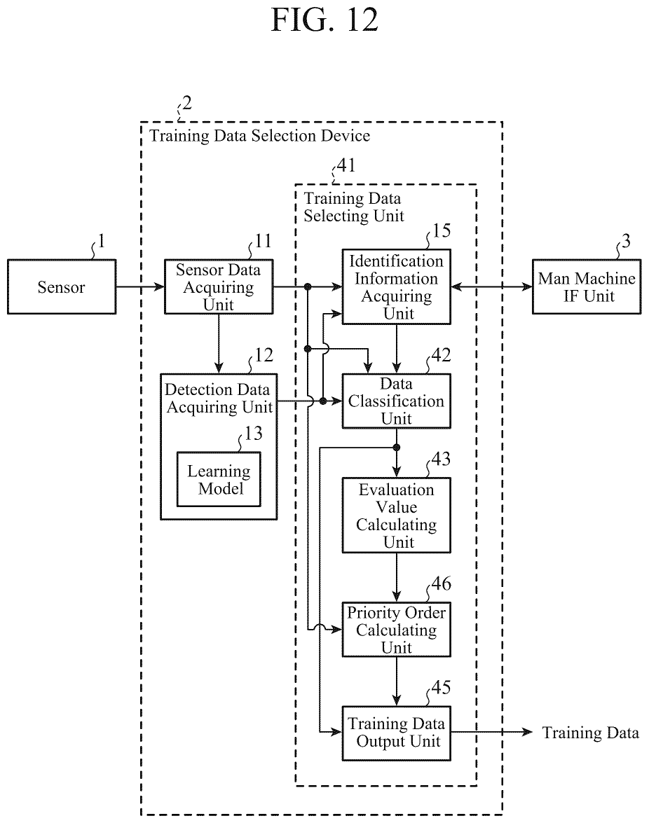

FIG. 12 is a configuration diagram illustrating the training data selection device 2 according to the third embodiment. In FIG. 12, the same reference numerals as in FIGS. 1 and 8 indicate the same or corresponding parts, and therefore description thereof is omitted.

The priority order calculating unit 46 acquires a first evaluation value of each piece of normal sensor data and a second evaluation value of each piece of normal sensor data from an evaluation value calculating unit 43.

The priority order calculating unit 46 acquires, from the sensor data acquiring unit 11, an acquisition time of each piece of normal sensor data by the sensor data acquiring unit 11.

The priority order calculating unit 46 calculates a third evaluation value of each piece of normal sensor data on the basis of the acquisition time of each piece of normal sensor data. The third evaluation value is a smaller value as the acquisition time of normal sensor data is older.

The priority order calculating unit 46 calculates a priority order of each piece of normal sensor data on the basis of the first evaluation value of each piece of positive sensor data, the second evaluation value of each piece of normal sensor data, and the third evaluation value of each piece of normal sensor data.

The priority order calculating unit 46 outputs the priority order of each piece of normal sensor data to a training data output unit 45.

Next, an operation of the training data selection device 2 illustrated in FIG. 12 will be described. Note that the training data selection device 2 is similar to the training data selection device 2 illustrated in FIG. 8 except for the priority order calculating unit 46. Therefore, only an operation of the priority order calculating unit 46 will be described here.

In the training data selection device 2 illustrated in FIG. 12, for convenience of description, an example in which pieces of the normal sensor data are D₁, D₂, D₃, and D₄, pieces of the false positive sensor data are FP₁ and FP₂, and pieces of the false negative sensor data are FN₁ and FN₂ will be described.

The priority order calculating unit 46 acquires a first evaluation value EV_{Dm-FP1}, EV_{Dm-FP2} of normal sensor data Dₘ and a second evaluation value EVD_{m-FN1}, EV_{Dm-FN2} of normal sensor data Dₘ from the evaluation value calculating unit 43. m=1, 2, 3, or 4

In addition, the priority order calculating unit 46 acquires, from the sensor data acquiring unit 11, an acquisition time tₘ of normal sensor data Dₘ by the sensor data acquiring unit 11.

The priority order calculating unit 46 calculates the third evaluation value of normal sensor data Dₘ on the basis of the acquisition time tₘ of normal sensor data Dₘ. The third evaluation value is a smaller value as the acquisition time tₘ of normal sensor data Dₘ is older. Since normal sensor data Dₘ having an older acquisition time tₘ is more likely to deviate from a distribution of pieces of sensor data at the current point, that is, a distribution of pieces of sensor data when the fault detection target is normal, the third evaluation value of normal sensor data Dₘ having an older acquisition time tₘ is calculated to be a smaller value.

For example, when the acquisition time t₂ of normal sensor data D₂ is the latest, the acquisition time t₄ of normal sensor data D₄ is the second latest, the acquisition time t₁ of normal sensor data D₁ is the third latest, and the acquisition time t₃ of normal sensor data D₃ is the oldest, the third evaluation value EV_{3,m} of normal sensor data Dₘ is, for example, as follows.
Third evaluation value EV_{3,1}=60
Third evaluation value EV_{3,2}=100
Third evaluation value EV_{3,3}=20
Third evaluation value EV_{3,4}=90

In this example, the value of the third evaluation value EV_{3,2} of normal sensor data D₂ is set to 100 on the basis of the latest acquisition time t₂ of normal sensor data D₂ among the acquisition times tₘ of normal sensor data Dₘ.

The priority order calculating unit 46 calculates a value proportional to a time difference Δtₘ between the acquisition time t₂ of normal sensor data D₂ and the acquisition time tₘ of another piece of normal sensor data Dₘ.

Then, the priority order calculating unit 46 sets a value obtained by subtracting a value proportional to the time difference Δtₘ from 100, which is the value of the third evaluation value EV_{3,2} of normal sensor data D₂, as the value of the third evaluation value EV_{3,m} of another piece of normal sensor data Dₘ.

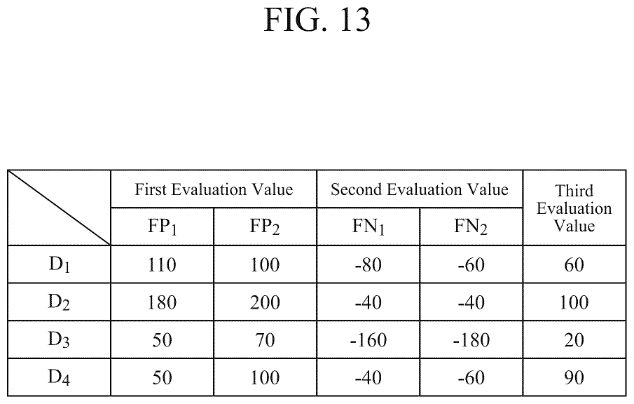

FIG. 13 is an explanatory diagram illustrating a first evaluation value, a second evaluation value, and a third evaluation value in each of the four pieces of normal sensor data illustrated in FIG. 10.

The priority order calculating unit 46 calculates a score SCₘ of normal sensor data Dₘ on the basis of the first evaluation value EV_{Dm-FP1}, EV_{Dm-FP2} of normal sensor data Dₘ, the second evaluation value EVD_{m-FN1}, EV_{Dm-FN2} of normal sensor data Dₘ, and the third evaluation value EV_{3,m} of normal sensor data Dₘ as expressed by the following equations (5) to (8).

$$\begin{matrix}{SC}_{1} = {EV}_{D 1 - FP 1} + {EV}_{D 1 - FP 2} + {EV}_{D 1 - FN 1} + {EV}_{D 1 - FN 2} + {EV}_{3 , 1} \\ = 110 + 100 - 80 - 60 + 60 \\ = 130\end{matrix} \qquad ( 5 )$$

$$\begin{matrix}{SC}_{2} = {EV}_{D 2 - FP 1} + {EV}_{D 2 - FP 2} + {EV}_{D 2 - FN 1} + {EV}_{D 2 - FN 2} + {EV}_{3 , 2} \\ = 180 + 200 - 40 - 40 + 100 \\ = 400\end{matrix} \qquad ( 6 )$$

$$\begin{matrix}{SC}_{3} = {EV}_{D 3 - FP 1} + {EV}_{D 3 - FP 2} + {EV}_{D 3 - FN 1} + {EV}_{D 3 - FN 2} + {EV}_{3 , 3} \\ = 50 + 70 - 160 - 180 + 20 \\ = - 200\end{matrix} \qquad ( 7 )$$

$$\begin{matrix}{SC}_{4} = {EV}_{D 4 - FP 1} + {EV}_{D 4 - FP 2} + {EV}_{D 4 - FN 1} + {EV}_{D 4 - FN 2} + {EV}_{3 , 4} \\ = 50 + 100 - 40 - 60 + 90 \\ = 140\end{matrix} \qquad ( 8 )$$

The priority order calculating unit 46 compares the four scores SC₁ to SC₄ with each other, and calculates a priority order of the four pieces of normal sensor data D₁, D₂, D₃, and D₄ on the basis of a comparison result of the scores SC₁ to SC₄. The higher the score SCₘ, the higher the priority order of normal sensor data Dₘ.

In the example of FIG. 13, the priority order of the normal sensor data D₂ is the first, the priority order of the normal sensor data D₄ is the second, the priority order of the normal sensor data D₁ is the third, and the priority order of the normal sensor data D₃ is the fourth.

In the example of FIG. 11, the priority order of the normal sensor data D₂ is the first, the priority order of the normal sensor data D₁ is the second, the priority order of the normal sensor data D₄ is the third, and the priority order of the normal sensor data D₃ is the fourth.

Therefore, the priority order of the normal sensor data D₁ and the priority order of the normal sensor data D₄ are reversed.

The priority order calculating unit 46 outputs the priority orders of the four pieces of normal sensor data D₁, D₂, D₃, and D₄ to the training data output unit 45.

In the third embodiment described above, the training data selection device 2 illustrated in FIG. 12 is configured in such a manner that the priority order calculating unit 46 calculates the third evaluation value of each piece of normal sensor data on the basis of the acquisition time of each piece of normal sensor data by the sensor data acquiring unit 11, and calculates the priority order of each piece of normal sensor data on the basis of each of the first evaluation value and the second evaluation value calculated by the evaluation value calculating unit 43 and the third evaluation value. Therefore, the training data selection device 2 illustrated in FIG. 12 can select training data capable of reducing erroneous detection that the fault detection target is detected to be normal although the fault detection target is abnormal similarly to the training data selection device 2 illustrated in FIG. 1. In addition, the training data selection device 2 illustrated in FIG. 12 can select training data capable of reducing erroneous detection that the fault detection target is abnormal although the fault detection target is normal similarly to the training data selection device 2 illustrated in FIG. 8. Furthermore, the training data selection device 2 illustrated in FIG. 12 can lower the priority order of each piece of normal sensor data as the acquisition time of each piece of normal sensor data by the sensor data acquiring unit 11 is older.

### Fourth Embodiment

In a fourth embodiment, a training data selection device 2 including a retraining unit 50 that retrains learning model 13 using training data selected by a training data selecting unit 14 will be described.

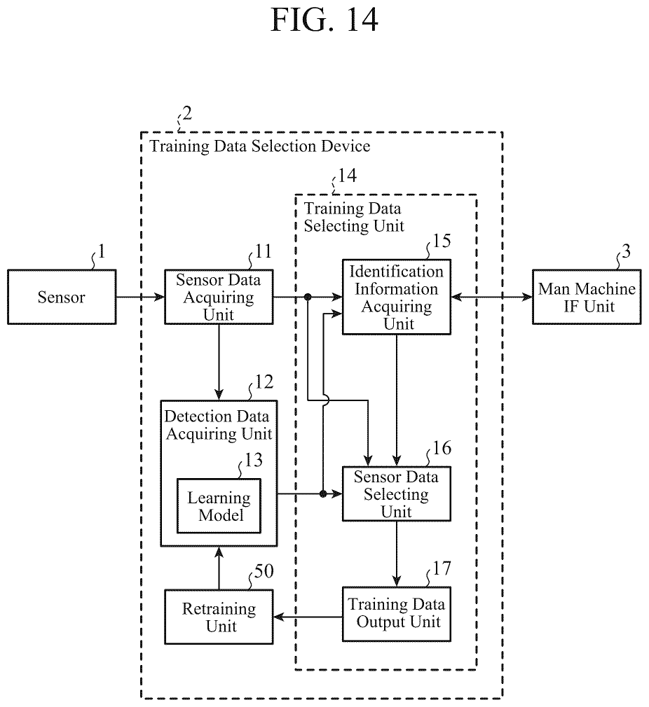

FIG. 14 is a configuration diagram illustrating the training data selection device 2 according to the fourth embodiment. In FIG. 14, the same reference numerals as in FIGS. 1, 8, and 12 indicate the same or corresponding parts, and therefore description thereof is omitted.

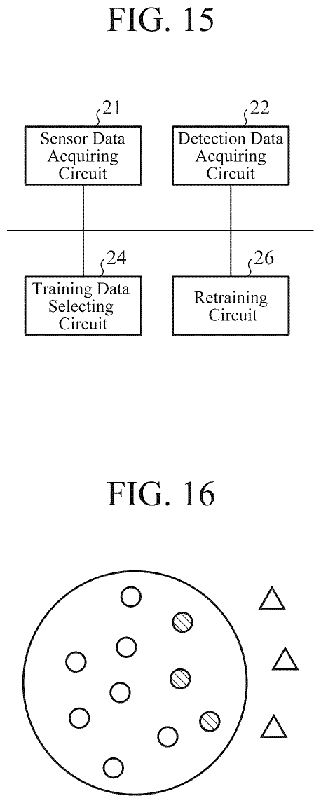

FIG. 15 is a hardware configuration diagram illustrating hardware of the training data selection device 2 according to the fourth embodiment. In FIG. 15, the same reference numerals as in FIGS. 2 and 9 indicate the same or corresponding parts, and therefore description thereof is omitted.

The training data selection device 2 illustrated in FIG. 14 includes a sensor data acquiring unit 11, a detection data acquiring unit 12, the training data selecting unit 14, and the retraining unit 50.

The retraining unit 50 is implemented by, for example, a retraining circuit 26 illustrated in FIG. 15.

The retraining unit 50 retrains the learning model 13 using training data selected by the training data selecting unit 14.

In the training data selection device 2 illustrated in FIG. 14, the retraining unit 50 is applied to the training data selection device 2 illustrated in FIG. 1. However, this is merely an example, and the retraining unit 50 may be applied to the training data selection device 2 illustrated in FIG. 8 or the training data selection device 2 illustrated in FIG. 12.

In FIG. 14, it is assumed that each of the sensor data acquiring unit 11, the detection data acquiring unit 12, the training data selecting unit 14, and the retraining unit 50, which are constituent elements of the training data selection device 2, is implemented by dedicated hardware as illustrated in FIG. 15. That is, it is assumed that the training data selection device 2 is implemented by a sensor data acquiring circuit 21, a detection data acquiring circuit 22, a training data selecting circuit 24, and the retraining circuit 26.

To each of the sensor data acquiring circuit 21, the detection data acquiring circuit 22, the training data selecting circuit 24, and the retraining circuit 26, for example, a single circuit, a composite circuit, a programmed processor, a parallel programmed processor, an ASIC, a FPGA, or a combination thereof corresponds.

The constituent elements of the training data selection device 2 are not limited to those implemented by dedicated hardware, and the training data selection device 2 may be implemented by software, firmware, or a combination of software and firmware.

When the training data selection device 2 is implemented by software, firmware, or the like, a program for causing a computer to execute processing procedures performed in each of the sensor data acquiring unit 11, the detection data acquiring unit 12, the training data selecting unit 14, and the retraining unit 50 is stored in the memory 31 illustrated in FIG. 3. The processor 32 illustrated in FIG. 3 executes the program stored in the memory 31.

FIG. 15 illustrates an example in which each of the constituent elements of the training data selection device 2 is implemented by dedicated hardware, and FIG. 3 illustrates an example in which the training data selection device 2 is implemented by software, firmware, or the like. However, this is merely an example, and some of the constituent elements of the training data selection device 2 may be implemented by dedicated hardware, and the remaining constituent elements may be implemented by software, firmware, or the like.

Next, an operation of the training data selection device 2 illustrated in FIG. 14 will be described. Note that the training data selection device 2 is similar to the training data selection device 2 illustrated in FIG. 1 except for the retraining unit 50. Therefore, only an operation of the retraining unit 50 will be described here.

The retraining unit 50 acquires normal sensor data and false positive sensor data from the training data selecting unit 14 as training data used for retraining of the learning model 13.

The retraining unit 50 retrains the learning model 13 using the normal sensor data and the false positive sensor data. As a result, the learning model 13 relearns a distribution of pieces of sensor data when the fault detection target is normal using the normal sensor data and the false positive sensor data. The distribution of pieces of sensor data after retraining does not include sensor data related to false negative detection data. As a result, the distribution of pieces of sensor data when the fault detection target is normal is an appropriate distribution.

When the retraining unit 50 retrains the learning model 13, as illustrated in FIG. 16, if a ratio at which the training data selected by the training data selecting unit 14 is included in the training data used for the previous training of the learning model 13 is equal to or less than a threshold, the retraining unit 50 may adjust a hyperparameter of the learning model 13 after retraining. The threshold may be stored in an internal memory of the retraining unit 50 or may be given from the outside of the training data selection device 2.

FIG. 16 is an explanatory diagram illustrating a ratio at which training data output from the training data selecting unit 14 is included in training data used for the previous training of the learning model 13.

In FIG. 16, ◯ represents a piece of normal sensor data, and ◯ shaded represents a piece of normal sensor data output as training data from the training data selecting unit 14 among the pieces of training data used for the previous training of the learning model 13. A represents a piece of false positive sensor data output as training data from the training data selecting unit 14.

The hyperparameter of the learning model 13 is, for example, a value for controlling behavior of an algorithm in the learning model 13. By adjusting the hyperparameter of the learning model 13, for example, improvement in performance of the learning model 13, suppression of over-learning, or improvement in learning efficiency is expected.

In the fourth embodiment described above, the training data selection device 2 illustrated in FIG. 14 is configured in such a manner as to include the retraining unit 50 that retrains the learning model 13 using training data selected by the training data selecting unit 14. Therefore, the training data selection device 2 illustrated in FIG. 14 can select training data capable of reducing erroneous detection that the fault detection target is detected to be normal although the fault detection target is abnormal similarly to the training data selection device 2 illustrated in FIG. 1, and can cause the learning model 13 to relearn a distribution of pieces of sensor data.

### Fifth Embodiment

In a fifth embodiment, an anomaly detection device including an anomaly detection unit 60 will be described.

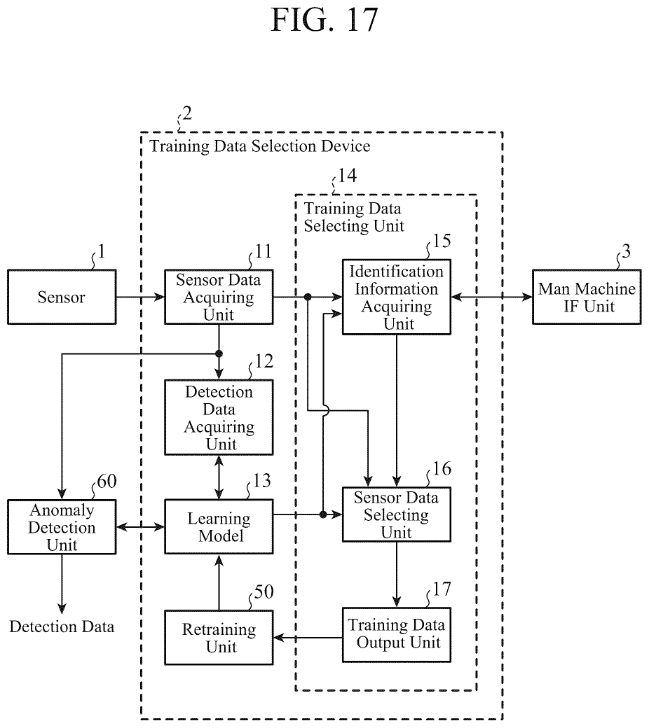

FIG. 17 is a configuration diagram illustrating the anomaly detection device according to the fifth embodiment. In FIG. 17, the same reference numerals as in FIG. 14 indicate the same or corresponding parts, and therefore description thereof is omitted.

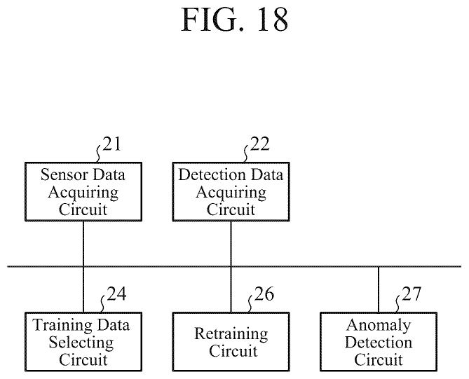

FIG. 18 is a hardware configuration diagram illustrating hardware of the anomaly detection device according to the fifth embodiment. In FIG. 18, the same reference numerals as in FIG. 15 indicate the same or corresponding parts, and therefore description thereof is omitted.

The anomaly detection device illustrated in FIG. 17 includes a training data selection device 2 and the anomaly detection unit 60.

In the anomaly detection device illustrated in FIG. 17, a learning model 13 is disposed outside a detection data acquiring unit 12. However, this is merely an example, and the detection data acquiring unit 12 may include the learning model 13. The learning model 13 is a learning model that has been caused to perform retraining of the retraining unit 50.

The anomaly detection unit 60 is implemented by, for example, an anomaly detection circuit 27 illustrated in FIG. 18.

The anomaly detection unit 60 gives sensor data acquired by a sensor data acquiring unit 11 to the learning model 13 after retraining after the retraining unit 50 retrains the learning model 13, and acquires detection data indicating whether the fault detection target is normal or abnormal from the learning model 13 after retraining.

The anomaly detection unit 60 outputs the detection data to the outside.

In FIG. 17, it is assumed that each of the sensor data acquiring unit 11, the detection data acquiring unit 12, a training data selecting unit 14, the retraining unit 50, and the anomaly detection unit 60, which are constituent elements of the anomaly detection device, is implemented by dedicated hardware as illustrated in FIG. 18. That is, it is assumed that the anomaly detection device is implemented by a sensor data acquiring circuit 21, a detection data acquiring circuit 22, a training data selecting circuit 24, a retraining circuit 26, and the anomaly detection circuit 27.

To each of the sensor data acquiring circuit 21, the detection data acquiring circuit 22, the training data selecting circuit 24, the retraining circuit 26, and the anomaly detection circuit 27, for example, a single circuit, a composite circuit, a programmed processor, a parallel programmed processor, an ASIC, a FPGA, or a combination thereof corresponds.

The constituent elements of the anomaly detection device are not limited to those implemented by dedicated hardware, and the training data selection device 2 may be implemented by software, firmware, or a combination of software and firmware.

When the anomaly detection device is implemented by software, firmware, or the like, a program for causing a computer to execute processing procedures performed in each of the sensor data acquiring unit 11, the detection data acquiring unit 12, the training data selecting unit 14, the retraining unit 50, and the anomaly detection unit 60 is stored in the memory 31 illustrated in FIG. 3. The processor 32 illustrated in FIG. 3 executes the program stored in the memory 31.

FIG. 18 illustrates an example in which each of the constituent elements of the anomaly detection device is implemented by dedicated hardware, and FIG. 3 illustrates an example in which the anomaly detection device is implemented by software, firmware, or the like. However, this is merely an example, and some of the constituent elements of the anomaly detection device may be implemented by dedicated hardware, and the remaining constituent elements may be implemented by software, firmware, or the like.

Next, an operation of the anomaly detection device illustrated in FIG. 17 will be described. Note that the anomaly detection unit is similar to the training data selection device 2 illustrated in FIG. 14 except for the anomaly detection unit 60. Therefore, only an operation of the anomaly detection unit 60 will be described here.

The anomaly detection unit 60 acquires sensor data from the sensor data acquiring unit 11 after the retraining unit 50 retrains the learning model 13.

The anomaly detection unit 60 gives sensor data to the learning model 13 after retraining, and acquires detection data indicating whether the fault detection target is normal or abnormal from the learning model 13 after retraining.

The anomaly detection unit 60 outputs the detection data to the outside.

In the fifth embodiment described above, the anomaly detection device is configured in such a manner as to include the training data selection device 2 illustrated in FIG. 14 and the anomaly detection unit 60 that gives sensor data acquired by the sensor data acquiring unit 11 to the learning model 13 after retraining after the retraining unit 50 retrains the learning model 13, and acquires detection data indicating whether the fault detection target is normal or abnormal from the learning model 13 after retraining. Therefore, the anomaly detection device can reduce erroneous detection that the fault detection target is detected to be normal although the fault detection target is abnormal.

Note that the present disclosure can freely combine the embodiments to each other, modify any constituent element in each of the embodiments, or omit any constituent element in each of the embodiments.

### INDUSTRIAL APPLICABILITY

The present disclosure is suitable for a training data selection device, a training data selection method, and an anomaly detection device.

### REFERENCE SIGNS LIST

1: sensor, 2: training data selection device, 3: man machine IF unit, 11: sensor data acquiring unit, 12: detection data acquiring unit, 13: learning model, 14: training data selecting unit, 15: identification information acquiring unit, 16: sensor data selecting unit, 17: training data output unit, 21: sensor data acquiring circuit, 22: detection data acquiring circuit, 24, 25: training data selecting circuit, 26: retraining circuit, 27: anomaly detection circuit, 31: memory, 32: processor, 41: training data selecting unit, 42: data classification unit, 43: evaluation value calculating unit, 44: priority order calculating unit, 45: training data output unit, 46: priority order calculating unit, 50: retraining unit, 60: anomaly detection unit

1. A training data selection device comprising processing circuitry
to perform acquisition of a plurality of pieces of sensor data indicating an observation result of a fault detection target from a sensor to observe the fault detection target,
to give each of the plurality of pieces of sensor data to a learning model that has learned a distribution of the plurality of pieces of sensor data when the fault detection target is normal, and to acquire each of pieces of detection data indicating whether the fault detection target is normal or abnormal from the learning model, and
to acquire identification information for identifying which piece of sensor data among the plurality of pieces of sensor data is related to false negative detection data indicating that the fault detection target is normal although the fault detection target is abnormal, and to perform selection of, on a basis of the identification information, a piece of sensor data related to detection data indicating that the fault detection target is normal as training data used for retraining of the learning model from other pieces of sensor data which are other than the piece of sensor data identified to be related to the false negative detection data among the plurality of pieces of sensor data, and to output the selected piece of sensor data for retraining.

2. The training data selection device according to claim 1, wherein
the processing circuitry
acquires identification information for identifying which piece of sensor data among the plurality of pieces of sensor data is related to false positive detection data indicating that the fault detection target is abnormal although the fault detection target is normal, and further selects, on a basis of the identification information, a piece of sensor data related to the false positive detection data as training data used for retraining of the learning model from the plurality of pieces of sensor data.

3. The training data selection device according to claim 2, wherein
the processing circuitry is further configured
to acquire identification information indicating which piece of sensor data is related to the false negative detection data, which piece of sensor data is related to the false positive detection data, and which piece of sensor data is related to detection data under normal conditions indicating that the fault detection target is normal when the fault detection target is normal among the plurality of pieces of sensor data,
to select the sensor data related to the detection data under normal conditions and the sensor data related to the false positive detection data from the plurality of pieces of sensor data on a basis of the identification information, and
to output the sensor data selected by the selection as training data used for retraining of the learning model.

4. The training data selection device according to claim 3, wherein
when the processing circuitry
acquires identification information indicating which piece of sensor data is related to the false negative detection data and which piece of sensor data is related to the false positive detection data, and does not acquire identification information indicating which piece of sensor data is related to the detection data under normal conditions among the plurality of pieces of sensor data,
the processing circuitry
selects a piece of sensor data other than the sensor data related to the false negative detection data as the sensor data related to the detection data under normal conditions from pieces of the sensor data related to detection data indicating that the fault detection target is normal among the plurality of pieces of sensor data on a basis of the identification information indicating which piece of sensor data is the sensor data related to the false negative detection data.

5. The training data selection device according to claim 3, wherein
when a similarity between the sensor data related to detection data under normal conditions and the sensor data related to the false positive detection data which are selected by the selection is equal to or more than a threshold, the processing circuitry outputs the sensor data related to the detection data under normal conditions as training data used for retraining of the learning model, and when the similarity is less than the threshold, the processing circuitry discards the sensor data related to the detection data under normal conditions.

6. The training data selection device according to claim 2, wherein
the processing circuitry is further configured
to acquire identification information indicating which piece of sensor data is related to the false negative detection data, which piece of sensor data is related to the false positive detection data, and which piece of sensor data is related to the detection data under normal conditions indicating that the fault detection target is normal when the fault detection target is normal among the plurality of pieces of sensor data,
to perform classification of each of the pieces of sensor data into false negative sensor data related to the false negative detection data, false positive sensor data related to the false positive detection data, or normal sensor data related to the detection data under normal conditions on a basis of the identification information,
to calculate, when there is a plurality of pieces of normal sensor data after the classification, as a first evaluation value of each of the pieces of normal sensor data, a positive sign evaluation value having a larger absolute value as a similarity between each of the pieces of normal sensor data and the false positive sensor data is higher, and calculate, as a second evaluation value of each of the pieces of normal sensor data, a negative sign evaluation value having a larger absolute value as a similarity between each of the pieces of normal sensor data and the false negative sensor data is higher,
to calculate a priority order of each of the pieces of normal sensor data on a basis of each of the first evaluation value and the second evaluation value, and to select one or more pieces of normal sensor data from the plurality of pieces of normal sensor data on a basis of the priority order, and to output the selected normal sensor data and the false positive sensor data as training data used for retraining of the learning model.

7. The training data selection device according to claim 6, wherein
when the processing circuitry
acquires identification information indicating which piece of sensor data is the sensor data related to the false negative detection data and which piece of sensor data is the sensor data related to the false positive detection data, and does not acquire identification information indicating which piece of sensor data is the sensor data related to the detection data under normal conditions among the plurality of pieces of sensor data,
the processing circuitry
selects a piece of sensor data other than the sensor data related to the false negative detection data as the sensor data related to the detection data under normal conditions from pieces of the sensor data related to detection data indicating that the fault detection target is normal among the plurality of pieces of sensor data on a basis of the identification information indicating which piece of sensor data is the sensor data related to the false negative detection data, and classifies the sensor data related to the detection data under normal conditions into the normal sensor data.

8. The training data selection device according to claim 6, wherein
the processing circuitry
selects N pieces (N is an integer of 1 or more) of normal sensor data with higher priority orders from the plurality of pieces of normal sensor data.

9. The training data selection device according to claim 6, wherein
the processing circuitry
selects one piece of normal sensor data in descending order of the priority order from the plurality of pieces of normal sensor data, and repeatedly selects one piece of normal sensor data until the selected one piece of normal sensor data is given to the learning model, retraining of the learning model is performed, and detection accuracy of the learning model after retraining is equal to or more than a threshold.

10. The training data selection device according to claim 6, wherein
the processing circuitry calculates, as a first evaluation value of each of the pieces of normal sensor data, a positive sign Euclidean distance having a larger absolute value as a similarity between each of the pieces of normal sensor data and the false positive sensor data is higher, and
calculates, as a second evaluation value of each of the pieces of normal sensor data, a negative sign Euclidean distance having a larger absolute value as a similarity between each of the pieces of normal sensor data and the false negative sensor data is higher.

11. The training data selection device according to claim 6, wherein
the processing circuitry
calculates a third evaluation value of each of the pieces of normal sensor data on a basis of a time of the acquisition of each of the pieces of normal sensor data, and
calculates a priority order of each of the pieces of normal sensor data on a basis of each of the first evaluation value and the second evaluation value and the third evaluation value.

12. The training data selection device according to claim 1, wherein the processing circuitry is further configured to retrain the learning model using the training data selected by the selection.

13. The training data selection device according to claim 12, wherein
when a ratio at which the training data selected by the selection is included in the training data used for previous training of the learning model is equal to or less than a threshold, the processing circuitry adjusts a hyperparameter of the learning model after retraining.

14. A training data selection method comprising:
acquiring a plurality of pieces of sensor data indicating an observation result of a fault detection target from a sensor to observe the fault detection target;
giving each of the pieces of sensor data to a learning model that has learned a distribution of pieces of sensor data when the fault detection target is normal, and
acquiring each of pieces of detection data indicating whether the fault detection target is normal or abnormal from the learning model; and
acquiring identification information for identifying which piece of sensor data among the plurality of pieces of sensor data is related to false negative detection data indicating that the fault detection target is normal although the fault detection target is abnormal, and selecting, on a basis of the identification information, a piece of sensor data related to detection data indicating that the fault detection target is normal as training data used for retraining of the learning model from pieces of sensor data other than the sensor data related to the false negative detection data among the plurality of pieces of sensor data, and outputting the selected piece of sensor data for retraining.

15. An anomaly detection device comprising:
the training data selection device according to claim 12, wherein the processing circuitry is further configured
to give sensor data to the learning model after retraining and to acquire detection data indicating whether the fault detection target is normal or abnormal from the learning model after retraining.
